(19) United States
(12) Patent Application Publication
(10) Pub. No.: US 2025/0242284 A1
(43) Pub. Date: Jul. 31, 2025

(54) SYSTEM AND METHODS FOR A FILTER WASHING STATION

(71) Applicant: K&N Engineering, Inc., Riverside, CA (US)

(72) Inventors: Steve Williams, Cherry Valley, CA (US); Humberto Marre, Riverside, CA (US); Noah Cuevas, Riverside, CA (US); Branden Kim, Riverside, CA (US); Joost Adriaans, Riverside, CA (US)

(73) Assignee: K&N Engineering, Inc., Riverside, CA (US)

(21) Appl. No.: 19/036,470

(22) Filed: Jan. 24, 2025

Related U.S. Application Data
(60) Provisional application No. 63/627,684, filed on Jan. 31, 2024.

(51) Int. Cl. B01D 41/04; B01D 29/56; B08B 3/02; B08B 3/08; B08B 3/14; F26B 5/08

(52) U.S. Cl. CPC B01D 41/04; B01D 29/56; B08B 3/02; B08B 3/08; B08B 3/14; F26B 5/08; B08B 2203/027

(57) ABSTRACT

A system and methods are provided for a filter washing station for cleaning and preparing filters for reuse. The filter washing station comprises a filter drawer for supporting the filters during cleaning and drying. Spray nozzles are disposed in the filter drawer for flushing contaminants from the filters. A water tank below the filter drawer stores a volume of cleaning fluid for cleaning the filters. The cleaning fluid is pumped from the water tank to the spray nozzles at a controlled flowrate and an adjustable pressure by way of a water pump. A wire mesh below the filter drawer removes contaminants from cleaning fluid draining from the filters into the water tank. One or more filter cartridges remove particles flowing with the cleaning fluid. Clean filters are subjected to spinning and/or shaking to throw off excess cleaning fluid and enhance drying of the filters.

### PRIORITY

This application claims the benefit of and priority to U.S. Provisional Application, entitled “System And Methods For A Filter Washing Station,” filed on Jan. 31, 2024, and having application Ser. No. 63/627,684, the entirety of said application being incorporated herein by reference.

### FIELD

Embodiments of the present disclosure generally relate to. More specifically, embodiments of the disclosure relate to a filter washing system and methods for cleaning and preparing filters for reuse.

### BACKGROUND

An air filter designed to remove particulate is generally a device composed of fibrous materials. These fibrous materials may remove solid particulates such as dust, pollen, mold, and bacteria from the air. Air filters are used in applications where air quality is important, notably in building ventilation systems and in automobile engines.

Air filters may be used in automobiles, trucks, tractors, locomotives and other vehicles that use internal combustion engines. Air filters may be used with gasoline engines, diesel engines, or other engines that run on fossil fuels or other combustible substances. Air filters may be used with engines in which combustion is intermittent, such as four-stroke and two-stroke piston engines, as well as other types of engines that take in air so as to burn a combustible substance. For example, air filters may be used with some gas turbines. Filters may also be used with air compressors or in other devices that take in air.

Filters may be made from pleated paper, foam, cotton, spun fiberglass, or other known filter materials. Generally, the air intakes of internal combustion engines and compressors tend to use paper, foam, or cotton filters. Some filters use an oil bath. Air filters for internal combustion engines prevent abrasive particulate matter from entering the engine's cylinders, where it would cause mechanical wear and oil contamination.

A drawback to paper air filters is that they must be thick, or the fibers must be tightly compressed and dense, which makes paper filters restrictive to air flow. Moreover, as a paper filter becomes more and more clogged with contaminants, the pressure inside the filter drops while the atmospheric air pressure outside the filter remains the same. When the pressure differential becomes too great, due to clogging, contaminants may be pulled through the restricted air filter into the engine. Thus, the performance of a paper air filter (i.e. air flow through the filter and its ability to protect the engine) decreases over the course of the filter's service life. Typically, a dirty paper air filter is removed from the vehicle and discarded, and a new paper air filter is then installed.

Considering that there are millions of vehicles throughout the world, the volume of discarded air filters that could be eliminated from landfills is a staggering number. In an attempt to reduce the number of discarded filters, some filters are configured to be periodically cleaned rather than replaced. In some instances, an air filter may be cleaned by removing the air filter from a vehicle, inserting a water hose into an interior cavity of the filter, and then spraying water to flush contaminants from the filter material. The cleaned air filter is then left to dry before being reinstalled into the vehicle.

A drawback to cleaning reusable air filters is that the cleaning process can be time consuming. In cases where a multiplicity of vehicles are operated and maintained, the time requirement for cleaning numerous air filters tends to encourage replacing conventional filters instead of reusing cleanable filters. Given the number of air filters in use, there is a continuing desire to make cleaning and reusing filters easy, cost effective, and less time consuming.

### SUMMARY

A system and methods are provided for a filter washing station for cleaning and preparing filters for reuse. The filter washing station comprises a filter drawer for supporting the filters during cleaning and drying. Spray nozzles are disposed in the filter drawer for flushing contaminants from the filters. A water tank below the filter drawer stores a volume of cleaning fluid for cleaning the filters. The cleaning fluid is pumped from the water tank to the spray nozzles at a controlled flowrate and an adjustable pressure by way of a water pump. A wire mesh below the filter drawer removes contaminants from cleaning fluid draining from the filters into the water tank. One or more filter cartridges remove particles flowing with the cleaning fluid. Clean filters are subjected to spinning and/or shaking to throw off excess cleaning fluid and enhance drying of the filters.

In an exemplary embodiment, a system for a filter washing station comprises: a filter drawer for housing one or more filters during cleaning and drying; one or more spray nozzles disposed in the filter drawer for flushing contaminants from the one or more filters; a water tank below the filter drawer for holding a volume of a cleaning fluid; a water pump for pumping the cleaning fluid to the one or more spray nozzles; a wire mesh above the water tank for removing contaminants from cleaning fluid draining from the one or more filters; and one or more filter cartridges for removing particles flowing with the cleaning fluid.

In another exemplary embodiment, the one or more filters comprise any type and configuration of filter having exposed filter material that is amenable to being sprayed with a cleaning fluid. In another exemplary embodiment, the filter washing station is configured to circulate cleaning water at a flowrate of about 10 GPM at a water pressure ranging between about 60 PSI and about 100 PSI. In another exemplary embodiment, the filter washing station is configured to enable the water pressure to be adjusted.

In another exemplary embodiment, the wire mesh comprises 304 stainless-steel with an opening size of about 0.032 inches to capture macroscopic particles flowing with the cleaning water. In another exemplary embodiment, a 90-micron sediment filter is disposed between the water tank and the water pump to remove macroparticles that may have passed through the wire mesh.

In another exemplary embodiment, the water pump comprises a 115V 10-stage booster pump; and wherein the one or more filter cartridges comprise one or more 50-micron filters configured to operate at a flowrate of about 10 GPM and a pressure of about 125 PSI. In another exemplary embodiment, a permeate tank is configured to receive the cleaning fluid from the one or more cartridges. In another exemplary embodiment, a secondary water pump is configured to pump the cleaning fluid from the permeate tank to the filters being cleaned inside the filter drawer. In another exemplary embodiment, the secondary water pump pushes the cleaning water to the filters by way of a piping system comprising a water manifold that provides one or more dedicated cleaning pipes.

In another exemplary embodiment, the one or more dedicated cleaning pipes include the one or more spray nozzles. In another exemplary embodiment, the one or more dedicated cleaning pipes and the one or more spray nozzles comprise at least one dedicated cleaning pipe and at least one spray nozzle for each of the one or more filters. In another exemplary embodiment, the one or more dedicated cleaning pipes includes three dedicated cleaning pipes that each supply the cleaning fluid to a spray nozzle at a flowrate between about 3-4 GPM and at a water pressure ranging between about 60 PSI and about 100 PSI.

In another exemplary embodiment, the system further comprises one or more DC motors each coupled with one of the one or more filters and configured to agitate the one or more filters during a drying process. In another exemplary embodiment, the one or more DC motors are configured to subject the one or more filters to any one or more of spinning, shaking vertically, shaking horizontally, or any combination thereof.

In another exemplary embodiment, the cleaning fluid comprises cleaning water that is sprayed onto the one or more filters to flush contaminants from the one or more filters. In another exemplary embodiment, the cleaning fluid comprises a cleaning solvent for cleaning filters that are treated with a filter oil composition that causes tackiness throughout the filter medium. In another exemplary embodiment, the cleaning solvent is configured to break up the filter oil composition and flush away any contaminants entrapped in the filter medium. In another exemplary embodiment, the filter washing station is configured to provide a combination cleaning cycle wherein the cleaning solvent is used to remove the filter oil composition and then water is used to flush contaminants from the one or more filters. In another exemplary embodiment, the filter washing station is configured to clean and dry the one or more filters before applying a new coat of a filter oil composition to filter media comprising the one or more filters.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a front isometric view of an exemplary embodiment of a filter washing station, according to the present disclosure;

FIG. 2 illustrates a rear isometric view of an exemplary embodiment of a filter washing station in accordance with the present disclosure;

FIG. 3 illustrates an exemplary-use environment wherein an exemplary embodiment of a filter washing station is configured for cleaning a V-bank air filter, according to the present disclosure;

FIG. 4 illustrates a front isometric view of a portion of the filter washing station of FIG. 3 in accordance with the present disclosure;

FIG. 5 is a flow chart illustrating an exemplary embodiment of a water cycle that may be incorporated into a filter washing station, according to the present disclosure;

FIG. 6 is a flow chart illustrating an exemplary embodiment of a process for servicing a reusable air filter in accordance with the present disclosure; and

FIG. 7 provides an exemplary block illustration of a data processing system that may be used in conjunction with a filter washing station in accordance with various embodiments of the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the filter washing station and methods disclosed herein may be practiced without these specific details. In other instances, specific numeric references such as “first filter,” may be made. However, the specific numeric reference should not be interpreted as a literal sequential order but rather interpreted that the “first filter” is different than a “second filter.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

As there are millions of vehicles throughout the world, the volume of discarded air filters that could be eliminated from landfills is a staggering number. In an attempt to reduce the number of discarded filters, some filters are configured to be periodically cleaned and reused rather than replaced. A drawback to cleaning reusable air filters, however, is that the cleaning process can be time consuming. In cases where a multiplicity of vehicles are operated and maintained, the time requirement for cleaning numerous air filters tends to encourage replacing conventional filters instead of reusing cleanable filters. Embodiments presented herein provide a system and method for a filter washing station that is configured to make cleaning and reusing filters easy, cost effective, and less time consuming.

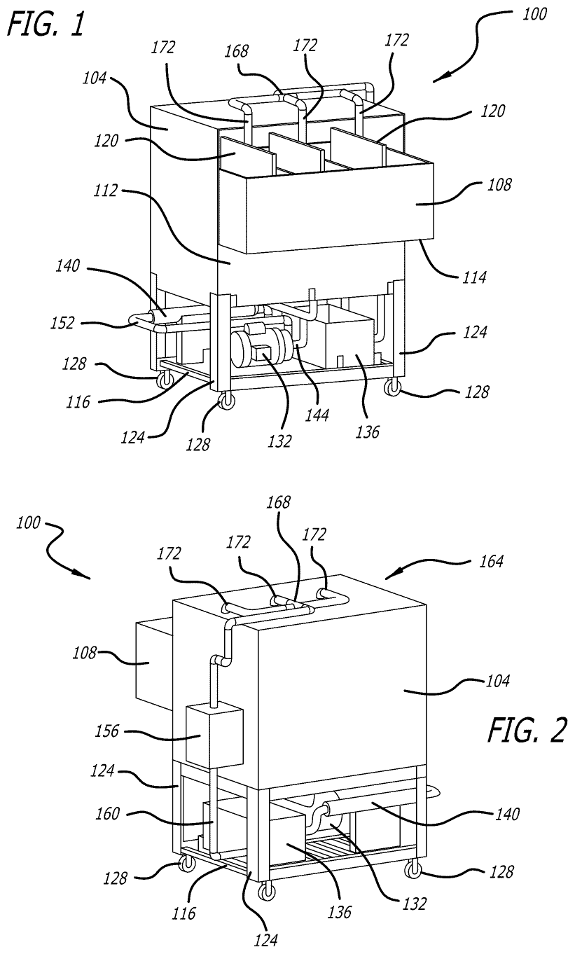

FIG. 1 illustrates a front isometric view of an exemplary embodiment of a filter washing station 100 that is configured to use cleaning water to flush contaminants from multiple filters simultaneously, according to the present disclosure. The illustrated embodiment of the filter washing station 100 is configured to circulate the cleaning water at 10 GPM (gallons per minute) at a water pressure ranging between about 60 PSI and about 100 PSI. It is contemplated that the filter washing station 100 is configured to enable the water pressure to be adjusted, as desired.

The filter washing station 100 includes a housing 104 that comprises a filter drawer 108, a water tank 112, a stainless-steel wire mesh 114, and a base 116. The filter drawer 108 is configured to support a multiplicity of filters 120 that are to be cleaned and dried for reuse, as described herein. The water tank 112 stores a volume of cleaning water that is cycled within the filter washing station 100 for flushing contaminants from the filters 120. In an embodiment, the volume of cleaning water is about 23.74 gallons. In an embodiment, the water tank 112 comprises a 27-gallon tank. The wire mesh 114 is configured to filter the cleaning water as it flows from the filter drawer 108 to the water tank 112. In an embodiment, the wire mesh 114 comprises 304 stainless-steel with an opening size of about 0.032 inches to capture macroscopic particles flowing with the cleaning water.

The base 116 supports components that circulate the cleaning water within the filter washing station 100, as described herein. Multiple support members 124 couple the base 116 with the housing 104 while wheels 128 underneath the base 116 enable moving the filter washing station 100. The wheels 128 may comprise casters made of any of polyolefin, polypropylene, polyurethane, or a similar material. In some embodiments, two of the wheels 128 are fixed with respect to the base 116 while two of the wheels 128 are free to swivel.

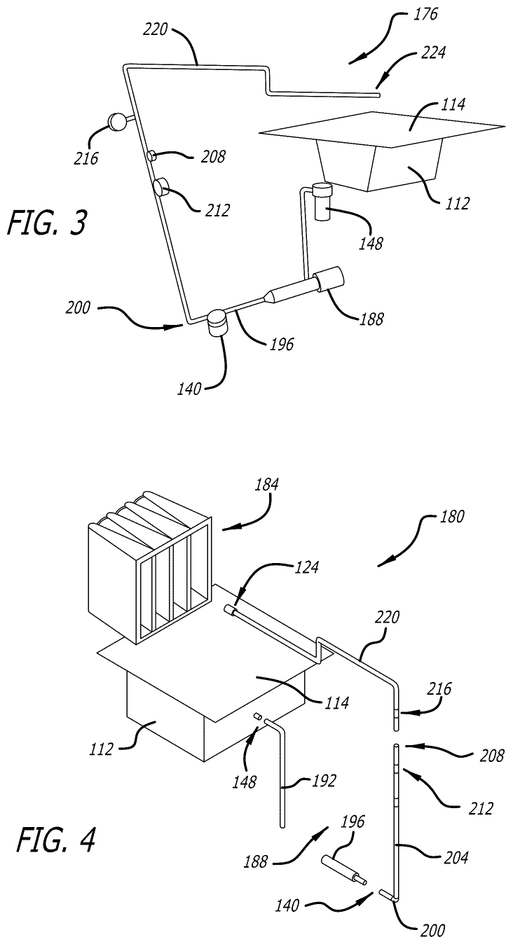

As shown in FIGS. 1-2, the base 116 supports a water pump 132, a permeate tank 136, and one or more filter cartridges 140. In some embodiments, the water pump 132 comprises a 115V 10-stage booster pump while the filter cartridges 140 comprise one or more 50-micron filters configured to operate at a flowrate of about 10 GPM and a pressure of about 125 PSI. In the illustrated embodiment, the water pump 132 receives cleaning water from the water tank 112 by way of pipes 144. In some embodiments, the pipes 144 may include a 90-micron sediment filter 148 (see FIGS. 3-4) to remove particles that may have passed through the wire mesh 114. Cleaning water exiting the water pump 132 is then directed to the filter cartridges 140 by way of pipes 152 before being passed into the permeate tank 136.

As best shown in FIG. 2, the illustrated embodiment of the filter washing station 100 includes a secondary water pump 156. The secondary water pump 156 is configured to pump cleaning water from the permeate tank 136 to the filters 120 being cleaned inside the filter drawer 108. The secondary water pump 156 draws cleaning water from the permeate tank 136 by way of pipes 160 and pushes the cleaning water to the filters 120 by way of a piping system 164. As shown in FIG. 1, the piping system 164 comprises a water manifold 168 that provides a dedicated cleaning pipe 172 for each filter 120 to be cleaned inside the filter drawer 108. As described hereinbelow, the dedicated cleaning pipes 172 include water nozzles configured to spray water onto the filters 120 so as to flush contaminants from the filters 120. The water and contaminants are passed to the bottom of the filter drawer 108 where the contaminants are strained by the wire mesh 114, while the water passes through the wire mesh 114 before being filtered and recirculated through the filter washing station 100 as described above.

It is contemplated that the filter washing station 100 may be configured to dry the filters 120 after the cleaning process is completed. In some embodiments, a DC motor may be coupled with each filter 120 and configured to spin the filters during a drying process. As will be appreciated, centrifugal forces during spinning the filters 120 will throw water off the filters 120 while air turbulence provides enhanced drying of the filters 120. In some embodiments, the filters 120 may be agitated, such as being shaken back and forth, to throw water off the filters 120 while introducing air turbulence for shortening drying times. In some embodiments, the filters 120 may be shaken along a vertical axis to throw water off the filters 120 while introducing air turbulence, as described. Thus, in some embodiments, the DC motors may be configured to subject the filters 120 to any one or more of spinning, shaking vertically, shaking horizontally, or any combination thereof.

Moreover, it should be borne in mind that that the filter washing station 100 is not limited to cleaning and drying only panel-shaped air filters, as shown in FIG. 1. Rather, the filter washing station 100 may be configured to clean and dry any type and configuration of filter having exposed filter material that is amenable to being sprayed with a cleaning fluid, without limitation. For example, the filter washing station 100 may be configured to clean and dry panel-shaped HVAC filters 120, as shown in FIG. 1, and also V-bank filters 184, as shown in FIG. 4. Further, in some embodiments, the filter washing station 100 may be configured to flush and dry any of various partially enclosed air filters having an exterior cross-sectional shape that may be generally circular, oval, or otherwise shaped so as to provide a relatively large surface area in a given volume of the air filter, without limitation.

It is contemplated that the filter washing station 100 may be configured to operate with a cleaning fluid other than water, without limitation. For example, in some embodiments, the filter washing station 100 may utilize a cleaning solvent for cleaning filters that are treated with a filter oil composition that causes tackiness throughout the air filter medium. In such embodiments, the cleaning solvent may be sprayed onto the filters to break up the filter oil composition and flush away any contaminants entrapped in the filter media. In some embodiments, the filter washing station 100 may be configured to provide a combination cleaning cycle wherein the cleaning solvent is used to remove the filter oil composition and then water is used to flush contaminants from the filters, as described herein. Further, it is contemplated that in some embodiments, the filter washing station 100 may be configured to clean and dry the filters, and then apply a new coat of filter oil composition to the filter media, without limitation.

FIG. 3 illustrates an exemplary-use environment 176 wherein an exemplary embodiment of a filter washing station 180 is configured for cleaning one or more V-bank air filters 184 (see FIG. 4), according to the present disclosure. As shown in FIG. 4, the filters 184 are flushed with cleaning water above a stainless-steel wire mesh 114 and a water tank 112. As described in connection with FIGS. 1-2, contaminants flushed from the filters 184 are captured by the wire mesh 114 while the water is collected in the water tank 112 before being filtered and recirculated through the filter washing station 180.

As shown in FIGS. 3-4, the filter washing station 180 includes a water pump 188, a sediment filter 148, and one or more filter cartridges 140. In some embodiments, the water pump 188 comprises a 115V 10-stage booster pump while the sediment filter 148 may comprise a 90-micron filter 148 configured to remove particles that may have passed through the wire mesh 114. As shown in FIG. 4, cleaning water exiting the sediment filter 148 is drawn to the water pump 188 through a pipe 192 and then moved to the filter cartridges 140 by way of pipes 196. The filter cartridges 140 may comprise one or more 50-micron filters configured to operate at a flowrate of about 10 GPM and at a pressure of about 125 PSI. In some embodiments, the filter cartridges 140 are washable disk elements. In some embodiments, the washable disk elements are 5-inch polyester elements that are rated for a flowrate of about 10 GPM at a pressure of about 60 PSI.

In the embodiment shown in FIGS. 3-4, cleaning water exiting the filter cartridges 140 passes through a check valve 200 before being pumped through a vertical pipe 204 to a pressure reducing valve 208. The check valve 200 is configured to prevent backflow of cleaning water, while the pressure reducing valve 208 is configured to control the pressure of the water being sprayed onto the filters 184. The illustrated pressure reducing valve 208 has a maximum pressure of about 150 PSI. Further, an upstream pressure gauge 212 and a downstream pressure gauge 216 are configured to facilitate determining a change in water pressure across the pressure reducing valve 208.

Water exiting pressure reducing valve 208 and the pressure gauges 212, 216 flows through a pipe system 220 to a spray nozzle 224 that is configured to flush contaminants from the filter 184, as shown in FIG. 4. In the illustrated embodiment of FIG. 4, the pipe system 220 comprises a single ½″ PVC pipe that feeds one spray nozzle 224 that is configured to direct a full cone spray pattern onto the filter 184. It is contemplated that the full cone spray pattern may comprise a 60-degree spray angle at a flowrate of about 10 GPM and a pressure of about 100 PSI.

In some embodiments, however, the filter washing station 180 may be configured to clean multiple filters 184 simultaneously. In such embodiments, the pipe system 220 may comprise multiple ⅜″ PVC pipes that each feeds a dedicated spray nozzle 224 for cleaning a single filter 184. The dedicated spray nozzle 224 may direct a full cone spray pattern at 120-degrees onto the filter 184. It is contemplated that the full cone spray pattern can have a 30-inch diameter at a flowrate between about 3-4 GPM and at a water pressure of about 60 PSI. As such, an embodiment of the filter washing station 180 that includes three dedicated spray nozzles 224 can operate at a total flowrate of about 10 GPM, as described herein.

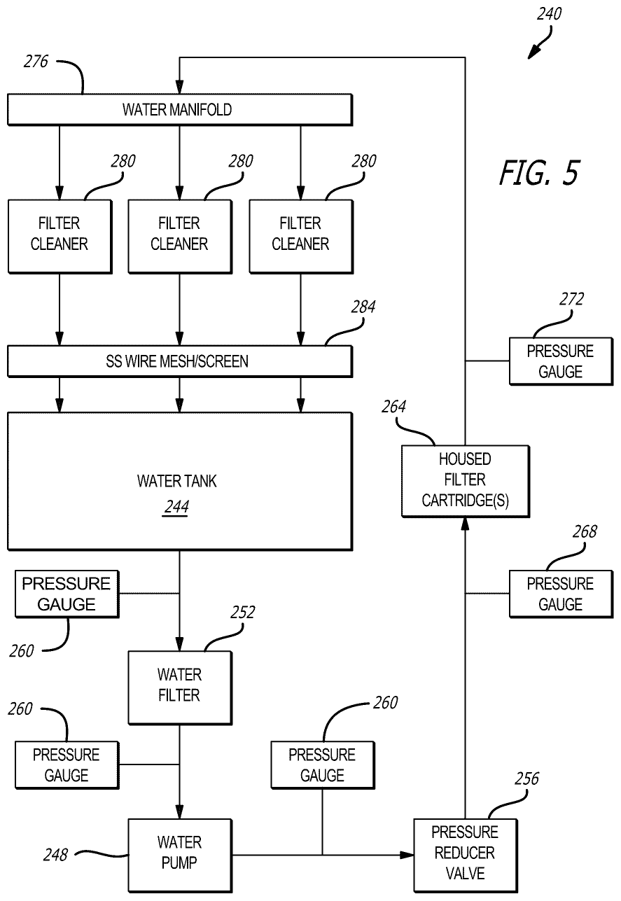

Turning, now, to FIG. 5, an exemplary embodiment of a water cycle 240 that may be incorporated into a filter washing station is shown, according to the present disclosure. The water cycle 240 generally begins with a water tank 244 and a water pump 248. The water tank 244 provides a reservoir that stores a volume of cleaning water that is cycled within the filter washing station, such as the washing station 100 shown in FIG. 1, for flushing contaminants from the filters 120. As shown in FIG. 5, the water pump 248 draws cleaning water from the water tank 244 through a water filter 252. The water pump 248 may comprise a 115V 10-stage booster pump while the water filter 252 may comprise a 90-micron sediment filter (see FIGS. 3-4) that is configured to remove macroparticles that may be flowing with the cleaning water.

In the water cycle 240 shown in FIG. 5, cleaning water exiting the water pump 248 passes to a pressure reducing valve 256. The pressure reducing valve 256 is configured to control the pressure of the water being sprayed onto the filters 120 to be cleaned. In some embodiments, the pressure reducing valve 256 has a maximum pressure of about 150 PSI. Further, multiple pressure gauges 260 are coupled with the water cycle 240 and configured to report the water pressure at locations between the water tank 244 and the water filter 252, between the water filter 252 and the water pump 248, as well as between the water pump 248 and the pressure reducer valve 256.

Next, cleaning water exiting the pressure reducer valve 256 is pumped to housed filter cartridges 264. In some embodiments, the housed filter cartridges 264 comprise one or more 50-micron filters configured to operate at a flowrate of about 10 GPM and at a pressure of about 125 PSI. In some embodiments, the housed filter cartridges 264 are washable disk elements. In some embodiments, the washable disk elements are 5-inch polyester elements that are rated for a flowrate of about 10 GPM at a pressure of about 60 PSI, as described hereinabove. Further, an upstream pressure gauge 268 and a downstream pressure gauge 272 are configured to facilitate observing the change in water pressure across the housed filter cartridges 264.

With continuing reference to FIG. 5, cleaning water exiting the housed filter cartridges 264 and the pressure gauges 268, 272 is pumped to a water manifold 276. The water manifold 276 distributes the cleaning water among multiple filter cleaners 280 that are each dedicated to flushing contaminants from a single filter, such as the filter 120 of FIG. 1 or the filter 184 of FIG. 4. The filter cleaners 280 may each provide a dedicated cleaning pipe 172 (FIG. 1) and a water nozzle for each filter to be cleaned. As described herein, the dedicated cleaning pipes 172 include water nozzles that are configured to spray cleaning water onto the filters 120 (184) so as to flush contaminants from the filters 120 (184). In some embodiments, the water nozzles may direct a full cone spray pattern at 120-degrees onto each filter. It is contemplated that the full cone spray pattern can have a 30-inch diameter at a flowrate between about 3-4 GPM and a water pressure of about 60 PSI. Next, the water and contaminants draining from the filters 120 passes to a stainless-steel wire mesh 284 that strains the contaminants allowing the water to drain into the tank 244 before being filtered and recirculated through the water cycle 240.

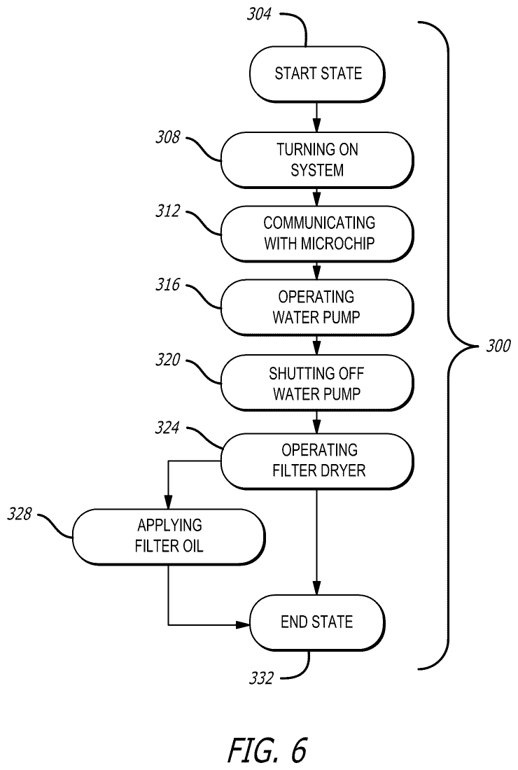

FIG. 6 is a flow chart illustrating an exemplary embodiment of a process 300 for servicing a reusable air filter in accordance with the present disclosure. The process 300 begins with a start state 304 that may include installing one or more reusable air filters (e.g., filters 120 of FIG. 1 or filter 184 of FIG. 4) into a filter washing station, such as the filter washing station 100 of FIG. 1. The start state 304 may further include closing a filter drawer 108 and supplying electric power to the filter washing station 100.

Next, the process 300 moves to step 308 comprising turning on the filter washing station 100. In some embodiments, step 308 includes using suitable circuitry to turn on a water pump 132 comprising the filter washing station 100. In some embodiments, the circuitry may be configured to operate the water pump 132 for about 90-seconds and then automatically turn off the water pump 132. In some embodiments, the step 308 includes supplying electric power to one or more microchips or microcontrollers comprising the circuitry of the filter washing station 100.

Step 312 comprises communicating with the one or more microchips or microcontrollers to cause the filter washing station 100 to clean the filters 120. In some embodiments, such communications can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

Step 316 comprises operating the water pump 132 to clean the filters 120. In some embodiments, the abovementioned circuitry may be configured to operate the water pump 132 for between about 90-seconds and about 120-seconds before automatically turning off the water pump 132. In some embodiments, the circuitry enables a practitioner to select a length of time to run the water pump 132. In some embodiments, the length of time is controlled by the communications with the one or more microcontrollers, performed in step 312. As will be appreciated, the length of time to run the water pump 132 generally comprises an amount of time required to advantageously flush contaminants from the filters 120.

Once the length of time to run the water pump 132 has elapsed, the process 300 advances to step 320 wherein the water pump 132 is turned off. It is contemplated that turning off the water pump 132 occurs after contaminants have been flushed from the filters 120. In some embodiments, one or more sensors may be used to detect the quantity of contaminants flowing with the water to the bottom of the filter drawer 108 or across the wire mesh 114 (see FIG. 1). As such, in some embodiments, the length of time to run the water pump 132 before turning off the pump in step 320 may be determined based on the quantity of contaminants flowing with the water. In such embodiments, the filters 120 can be considered “clean” once the quantity of contaminants flowing with the water decreases below a threshold value.

Once the filters 120 have been advantageously flushed free of contaminants, the process 300 moves to step 324, wherein the filters 120 are subjected to a drying process. As described with respect to FIGS. 1-2, a DC motor may be coupled with each filter 120 and configured to spin the filters 120 during the drying process. It is contemplated that centrifugal forces during spinning the filters 120 throws excess water off the filters 120 while air turbulence provides enhanced drying of the filters 120. In some embodiments, the filters 120 may be agitated, such as being shaken horizontally, to throw excess water off the filters 120 while introducing air turbulence to shorten the drying time. In some embodiments, the filters 120 may be shaken vertically to throw excess water off the filters 120 while introducing air turbulence, as described. It is contemplated that the filters 120 may be subjected to any path that is found to effectively throw water off the filters 120, without limitation.

In some embodiments, the process 300 may be used to clean and service reusable filters 120 that include a filter oil composition that causes tackiness throughout a filter media of the filters 120. It is contemplated that a practitioner may specify a filter type (e.g., “oiled” or “non-oiled”) in steps 312-316. When filters 120 of the oiled variety are cleaned and dried in step 324, a filter oil composition may be applied to the filters 120 in step 328. In some embodiments, the filter washing station 100 may include a dedicated pipe and spray nozzle configured to spray the filter oil composition onto the filters 120.

Once the filters 120 have been advantageously treated with the filter oil composition, the process 300 moves to an end state 332, wherein the filters 120 may be removed from the filter drawer 108 and returned to service. When the filters 120 are the non-oiled variety, the process 300 skips step 328 and moves directly from step 324 to the end state 332. In some embodiments, the filter washing machine 100 may be configured to indicate to a practitioner when the filters 120 are ready to be removed from the filter drawer 108. For example, in some embodiments, a light may illuminate and/or an audible alarm may sound when the filters 120 are ready to be removed from the filter drawer 108.

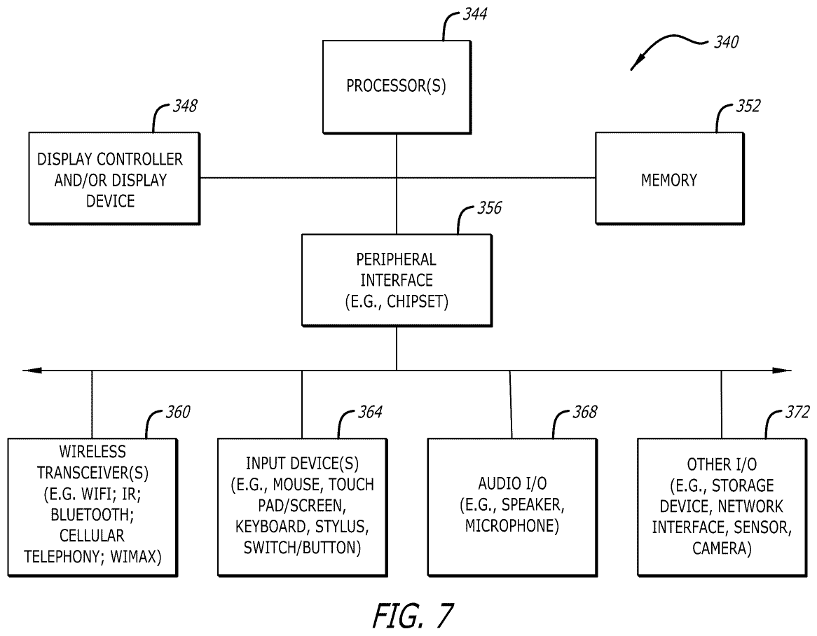

Turning, now, to FIG. 7, a block diagram illustrates an exemplary data processing system 340 that may be used in conjunction with the filter washing station 100 to perform any of the processes or methods described herein. Data processing system 340 may represent circuitry within a desktop, a tablet, a server, a mobile phone, a personal digital assistant (PDA), a personal communicator, a network router or hub, a wireless access point (AP) or repeater, a set-top box, or any combination thereof.

In an embodiment, illustrated in FIG. 7, system 340 includes a processor 344 and a peripheral interface 356, also referred to herein as a chipset, to couple various components to the processor 344, including a memory 352 and devices 360-372 via a bus or an interconnect. Processor 344 may represent a single processor or multiple processors with a single processor core or multiple processor cores included therein. Processor 344 may represent one or more general-purpose processors such as a microprocessor, a central processing unit (CPU), or the like. More particularly, processor 344 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 344 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 344 is configured to execute instructions for performing the operations and steps discussed herein.

Peripheral interface 356 may include a memory control hub (MCH) and an input output control hub (ICH). Peripheral interface 356 may include a memory controller (not shown) that communicates with a memory 352. The peripheral interface 356 may also include a graphics interface that communicates with graphics subsystem 348, which may include a display controller and/or a display device. The peripheral interface 356 may communicate with the graphics device 348 by way of an accelerated graphics port (AGP), a peripheral component interconnect (PCI) express bus, or any other type of interconnect.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 344. In such a configuration, the peripheral interface 356 operates as an interface chip performing some functions of the MCH and ICH. Furthermore, a graphics accelerator may be integrated within the MCH or the processor 344.

Memory 352 may include one or more volatile storage (or memory) devices, such as random access memory (RAM), dynamic RAM (DRAM), synchronous DRAM (SDRAM), static RAM (SRAM), or other types of storage devices. Memory 352 may store information including sequences of instructions that are executed by the processor 344, or any other device. For example, executable code and/or data of a variety of operating systems, device drivers, firmware (e.g., input output basic system or BIOS), and/or applications can be loaded in memory 352 and executed by the processor 344. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 356 may provide an interface to IO devices, such as the devices 360-372, including wireless transceiver(s) 360, input device(s) 364, audio IO device(s) 368, and other IO devices 372. Wireless transceiver 360 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 364 may include a mouse, a touch pad, a touch sensitive screen (which may be integrated with display device 348), a pointer device such as a stylus, and/or a keyboard (e.g., physical keyboard or a virtual keyboard displayed as part of a touch sensitive screen). For example, the input device 364 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 368 may include a speaker and/or a microphone to facilitate voice-enabled functions, such as voice recognition, voice replication, digital recording, and/or telephony functions. Other optional devices 372 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 372 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 7 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the filter washing station and methods have been described in terms of particular variations and illustrative figures, those of ordinary skill in the art will recognize that the filter washing station is not limited to the variations or figures described. In addition, where methods and steps described above indicate certain events occurring in certain order, those of ordinary skill in the art will recognize that the ordering of certain steps may be modified and that such modifications are in accordance with the variations of the filter washing station. Additionally, certain of the steps may be performed concurrently in a parallel process, when possible, as well as performed sequentially as described above. To the extent there are variations of the filter washing station, which are within the spirit of the disclosure or equivalent to the filter washing station found in the claims, it is the intent that this patent will cover those variations as well. Therefore, the present disclosure is to be understood as not limited by the specific embodiments described herein, but only by scope of the appended claims.

What is claimed is:

1. A system for a filter washing station, the system comprising:
a filter drawer for housing one or more filters during cleaning and drying;
one or more spray nozzles disposed in the filter drawer for flushing contaminants from the one or more filters;
a water tank below the filter drawer for holding a volume of a cleaning fluid;
a water pump for pumping the cleaning fluid to the one or more spray nozzles;
a wire mesh above the water tank for removing contaminants from cleaning fluid draining from the one or more filters; and
one or more filter cartridges for removing particles flowing with the cleaning fluid.

2. The system of claim 1, wherein the one or more filters comprise any type and configuration of filter having exposed filter material that is amenable to being sprayed with a cleaning fluid.

3. The system of claim 1, wherein the filter washing station is configured to circulate cleaning water at a flowrate of about 10 GPM at a water pressure ranging between about 60 PSI and about 100 PSI.

4. The system of claim 1, wherein the filter washing station is configured to enable the water pressure to be adjusted.

5. The system of claim 1, wherein the wire mesh comprises 304 stainless-steel with an opening size of about 0.032 inches to capture macroscopic particles flowing with the cleaning water.

6. The system of claim 1, wherein a 90-micron sediment filter is disposed between the water tank and the water pump to remove macroparticles that may have passed through the wire mesh.

7. The system of claim 1, wherein the water pump comprises a 115V 10-stage booster pump; and wherein the one or more filter cartridges comprise one or more 50-micron filters configured to operate at a flowrate of about 10 GPM and a pressure of about 125 PSI.

8. The system of claim 7, wherein a permeate tank is configured to receive the cleaning fluid from the one or more cartridges.

9. The system of claim 8, wherein a secondary water pump is configured to pump the cleaning fluid from the permeate tank to the filters being cleaned inside the filter drawer.

10. The system of claim 9, wherein the secondary water pump pushes the cleaning water to the filters by way of a piping system comprising a water manifold that provides one or more dedicated cleaning pipes.

11. The system of claim 10, wherein the one or more dedicated cleaning pipes include the one or more spray nozzles.

12. The system of claim 11, wherein the one or more dedicated cleaning pipes and the one or more spray nozzles comprise at least one dedicated cleaning pipe and at least one spray nozzle for each of the one or more filters.

13. The system of claim 12, wherein the one or more dedicated cleaning pipes includes three dedicated cleaning pipes that each supply the cleaning fluid to a spray nozzle at a flowrate between about 3-4 GPM and at a water pressure ranging between about 60 PSI and about 100 PSI.

14. The system of claim 1, further comprising one or more DC motors each coupled with one of the one or more filters and configured to agitate the one or more filters during a drying process.

15. The system of claim 14, wherein the one or more DC motors are configured to subject the one or more filters to any one or more of spinning, shaking vertically, shaking horizontally, or any combination thereof.

16. The system of claim 1, wherein the cleaning fluid comprises cleaning water that is sprayed onto the one or more filters to flush contaminants from the one or more filters.

17. The system of claim 1, wherein the cleaning fluid comprises a cleaning solvent for cleaning filters that are treated with a filter oil composition that causes tackiness throughout the filter medium.

18. The system of claim 17, wherein the cleaning solvent is configured to break up the filter oil composition and flush away any contaminants entrapped in the filter medium.

19. The system of claim 18, wherein the filter washing station is configured to provide a combination cleaning cycle wherein the cleaning solvent is used to remove the filter oil composition and then water is used to flush contaminants from the one or more filters.

20. The system of claim 18, wherein the filter washing station is configured to clean and dry the one or more filters before applying a new coat of a filter oil composition to filter media comprising the one or more filters.
